(19) United States
(12) Patent Application Publication
(10) Pub. No.: US 2024/0378321 A1
(43) Pub. Date: Nov. 14, 2024

(54) SNAPSHOT TAMPERING PREVENTION AND EFFICIENT DATA RESTORE FROM AN UNBREAKABLE SNAPSHOT

(71) Applicant: INTERNATIONAL BUSINESS MACHINES CORPORATION, ARMONK, NY (US)

(72) Inventors: Angel Nunez Mencias, Stuttgart (DE); ANBAZHAGAN Mani, Bangalore (IN); Subramaniyan Nallasivam, Bangalore (IN); Dileep Dixith, Hyderabad (IN)

(21) Appl. No.: 18/314,858

(22) Filed: May 10, 2023

(51) Int. Cl. G06F 21/64; G06F 11/14; G06F 16/11

(52) U.S. Cl. CPC G06F 21/64; G06F 11/1471; G06F 16/128; G06F 2201/84

(57) ABSTRACT

Systems and Methods for creating an immutable snapshot of a data volume and restoring the data volume from the immutable snapshot. A snapshot is created. For each file, a checksum is calculated. A string is created by concatenating the checksums in ascending order. That string is input to a linear aggregation method to create an aggregation checksum signature. The aggregation checksum signature, and each checksum along with and its associated file are stored as metadata in the snapshot.

### BACKGROUND

This invention relates generally to computer systems, and more particularly to data snapshot integrity.

Immutable snapshots are taken at regular intervals. Whenever data is compromised or a file is deleted or overwritten in error, snapshots are restored to ensure business continuity. In the Virtual Private Cloud (VPC) snapshots are read-only to the client. If an attacker is able to compromise the VPC the attacker may be able to delete a snapshot and continue, for example, by infecting the VPC with malware.

As ransomware attacks are increasing and evolving in sophistication of variants, vectors, and methodology, it would be advantageous to provide an unbreakable snapshot that is resistant to unauthorized alteration, thereby making an efficient recovery strategy possible.

### SUMMARY

A system is provided for creating an immutable snapshot of a data volume and restoring the data volume from the immutable snapshot. A snapshot is created. For each file, a checksum is calculated. A string is created by concatenating the checksums in ascending order. That string is input to a linear aggregation method to create an aggregation checksum signature. The aggregation checksum signature, and each checksum along with and its associated file are stored as metadata in the snapshot.

Embodiments are further directed to computer systems and computer program products having substantially the same features as the above-described computer-implemented method.

### BRIEF DESCRIPTION OF THE SEVERAL VIEWS OF THE DRAWINGS

FIG. 1 illustrates the operating environment of a computer server for snapshot tampering prevention and efficient restore; and

FIG. 2 is a flow diagram of an embodiment of a computing core in accordance with the present disclosure.

### DETAILED DESCRIPTION OF THE INVENTION

Immutable snapshots of critical data are taken at regular intervals. Whenever data is compromised or a file is deleted or overwritten in error, snapshots are restored to ensure business continuity. In the Virtual Private Cloud (VPC) snapshots are read-only to the client.

If an attacker is able to compromise the VPC the attacker may be able to delete or corrupt a snapshot and continue, for example, by infecting the VPC with malware.

In addition to regularly taking data snapshots, ensuring their integrity is a significant part of a comprehensive recovery strategy. For example, a snapshot can be stored as write-once-read-many times (WORM) media. As another example, time-based key encryption is a common form of two factor authentication, whereby an algorithm generates unique passwords. The password must be correctly entered before the password expires in order to gain access to the protected resource.

In a multi-vendor, multisite storage enterprise, there is a possibility that the data content within a snapshot could be vulnerable to cybersecurity threats. As the number of files in the snapshot increases, so may the snapshot's vulnerability to malicious tampering. Similarly, when snapshots are taken on a frequent schedule, many snapshots may be needed for recovery, thereby increasing the possibility of encountering a compromised snapshot during recovery. When a storage volume is compromised, for example, the snapshots are applied up to the point the storage volume is compromised. Activity that occurred beyond that point is lost.

The present invention protects the integrity of system recovery using snapshots by restoring the data volume from the immutable snapshot. During recovery, the checksums of each of the files are verified against the checksums from when the snapshot was created. If an infected file is identified, the recovery process will replace the infected file with a non-infected alternative file and the recovery is able to continue.

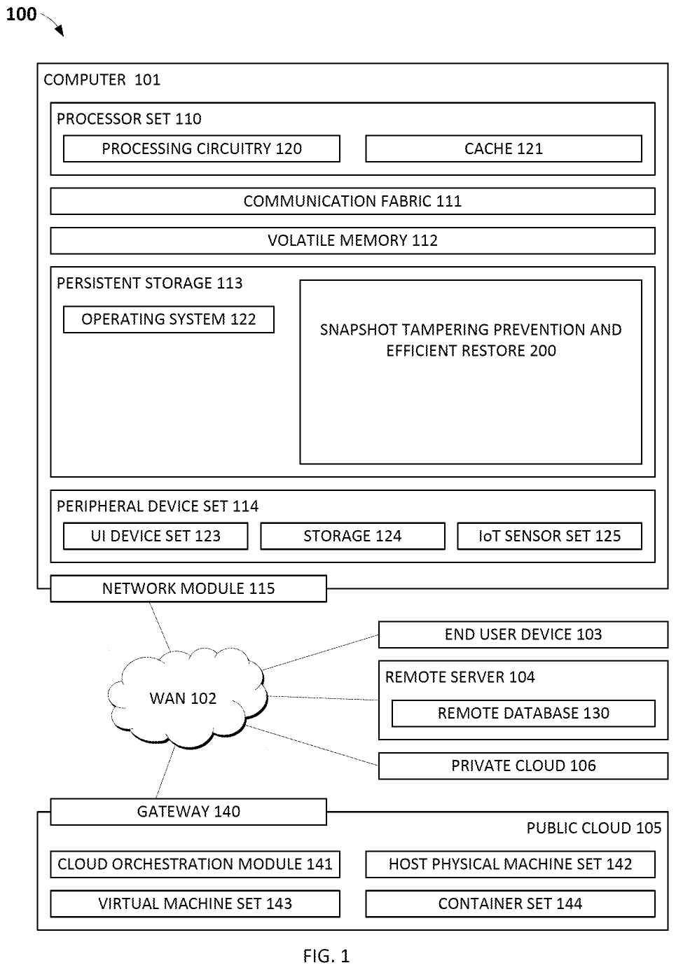

Beginning now with FIG. 1, an illustration is presented of the operating environment of a networked computer, according to an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as the snapshot tampering prevention and efficient restore (system) 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, an administrator that operates computer 101), and may take any of the forms discussed above in connection with computer 101. For example, EUD 103 can be the external application by which an end user connects to the control node through WAN 102. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

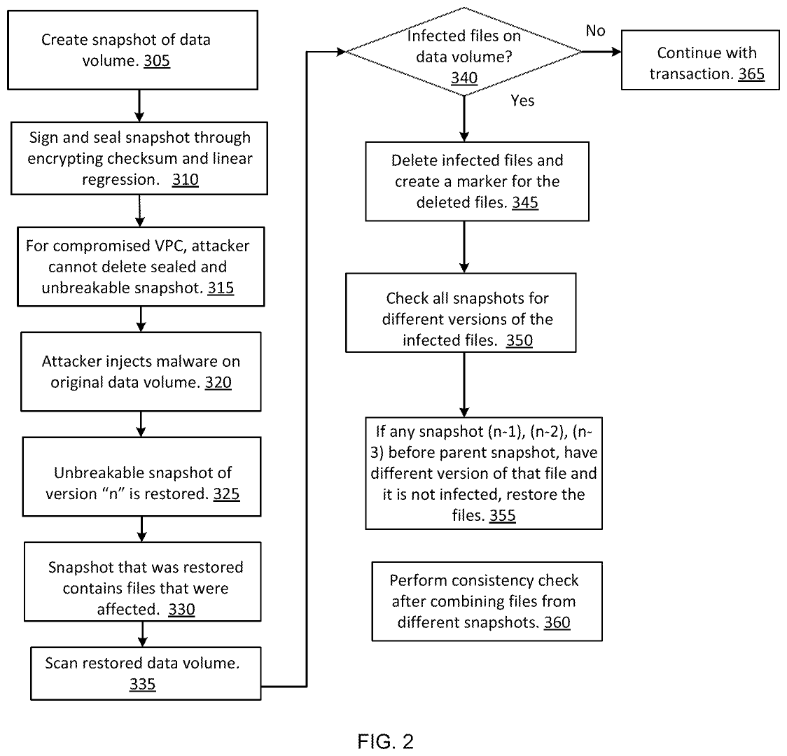

Turning now to FIG. 2, embodiments of the present invention include a cloud storage (primary storage) that is connected to cloud object storage (secondary storage), where the snapshots are stored. Cloud storage comprises non-volatile memory disks, such as flash memory. Each cloud object includes the data, its associated metadata, and an identifier.

The following is an example of syntax that may be used to create, make immutable, and store a snapshot in the cloud object storage:

```
createsnapshotresponse = client.createsnapshotaction (
  snapshot.Name = string
  snapshot.id = int
  snapshot.sec.referencevolumeid = int
  checksum = string
  checksum-aggregation-method = linear
)
```

During the snapshot creation (305), the system 200 calculates a checksum for each file being backed up. Each of the checksums is stored as metadata along with the file name of the associated file. Following the checksum creation process at the file level, the system 200 concatenates the created checksums, in ascending order, into a string.

The string is input to the linear aggregation method (310) to calculate an aggregation checksum signature, which is also stored with the individual checksums. The aggregation checksum signature is stored with the snapshot metadata. The aggregation checksum is evidence that the snapshot is immutable and cannot be deleted or further infected (315).

In an example, assume an attacker had injected malware on the original data volume, and recovery from snapshots is required (320). However, when the snapshot required for recovery, snapshot “n, was created, one or more files were already compromised by malware but were included in the snapshot (325, 330). After snapshot “n” is restored (325), the data volume is scanned again for infected files (335). If there are no infected files on the data volume, the restore is complete (365). However, if infected files are on the data volume, the system (200) deletes the infected files and replaces each one with a marker (345). All previous snapshots are checked for different versions of the infected file(s) (350). This ensures that all infected versions are removed from the backup data all the way back to the point of the original malware introduction. If any of the snapshots “n-1” back to the parent have a version of the file that is not infected, the system 200 restores that version of the file (355). After all the required files are restored, the system 200 performs another consistency scan (360) to ensure that all the infected files have been identified and removed.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprising:
creating a snapshot of a data volume;
during the creating of the snapshot, calculating a checksum for each file being included in the snapshot;
creating a string by concatenating the checksums by ascending order in the snapshot;
inputting the string to a linear aggregation method, and receiving an aggregation checksum signature; and
storing the snapshot and snapshot metadata.

2. The method of claim 1, wherein the snapshot is immutable.

3. The method of claim 1, wherein the stored snapshot includes metadata, the metadata comprising the aggregation checksum signature, and each checksum and filename in the snapshot.

4. The method of claim 1, further comprising:
restoring the snapshot based on one or more files of the data volume being corrupted;
based on a scan of the restored data volume detecting one or more corrupted files from the snapshot, deleting the one or more corrupted files, and replacing the deleted file with a marker place holder;
searching each previous snapshot for replacement versions of the one or more corrupted files that is not infected; and
in response to locating the replacement version, restoring the replacement version.

5. The method of claim 4, further comprising scanning the data volume after replacing the marker place holders with replacement versions that are not infected.

6. The method of claim 1, further comprising connecting a first cloud storage with a second cloud storage.

7. The method of claim 1, wherein the immutable snapshot is stored in a second cloud storage.

8. A computer program product, the computer program product comprising a non-transitory tangible storage device having program code embodied therewith, the program code executable by a processor of a computer to perform a method, the method comprising:
creating a snapshot of a data volume;
during the creating of the snapshot, calculating a checksum for each file being included in the snapshot;
creating a string by concatenating the checksums by ascending order in the snapshot;
inputting the string to a linear aggregation method, and receiving an aggregation checksum signature; and
storing the snapshot and snapshot metadata.

9. The computer program product of claim 8, wherein the snapshot is immutable.

10. The computer program product of claim 8, wherein the stored snapshot includes metadata, the metadata comprising the aggregation checksum signature, and each checksum and filename in the snapshot.

11. The computer program product of claim 8, further comprising:
restoring the snapshot based on one or more files of the data volume being corrupted;
based on a scan of the restored data volume detecting one or more corrupted files from the snapshot, deleting the one or more corrupted files, and replacing the deleted file with a marker place holder;
searching each previous snapshot for replacement versions of the one or more corrupted files that is not infected; and
in response to locating the replacement version, restoring the replacement version.

12. The computer program product of claim 7, further comprising scanning the data volume after replacing the marker place holders with replacement versions that are not infected.

13. The computer program product of claim 8, further comprising connecting a first cloud storage with a second cloud storage.

14. The computer program product of claim 8, wherein the immutable snapshot is stored in a second cloud storage.

15. A computer system, comprising:
one or more processors;
a memory coupled to at least one of the processors;
a set of computer program instructions stored in the memory and executed by at least one of the processors in order to perform actions of:
creating a snapshot of a data volume;
during the creating of the snapshot, calculating a checksum for each file being included in the snapshot;
creating a string by concatenating the checksums by ascending order in the snapshot;
inputting the string to a linear aggregation method, and receiving an aggregation checksum signature; and
storing the snapshot and snapshot metadata.

16. The computer system of claim 15, wherein the snapshot is immutable.

17. The computer system of claim 15, wherein the stored snapshot includes metadata, the metadata comprising the aggregation checksum signature, and each checksum and filename in the snapshot.

18. The computer system of claim 15, further comprising:
restoring the snapshot based on one or more files of the data volume being corrupted;
based on a scan of the restored data volume detecting one or more corrupted files from the snapshot, deleting the one or more corrupted files, and replacing the deleted file with a marker place holder;
searching each previous snapshot for replacement versions of the one or more corrupted files that is not infected; and
in response to locating the replacement version, restoring the replacement version.

19. The computer system of claim 18, further comprising scanning the data volume after replacing the marker place holders with replacement versions that are not infected.

20. The computer system of claim 15, further comprising connecting a first cloud storage with a second cloud storage, wherein the immutable snapshot is stored in a second cloud storage.
